(19) United States
(12) Patent Application Publication
(10) Pub. No.: US 2001/0035712 A1
(43) Pub. Date: Nov. 1, 2001

(54) Rugged high vacuum display

(76) Inventors: Seth A. Berman, Marblehead, MA (US); Peter Koufopoulous, Millis, MA (US); Alan Palevsky, Wayland, MA (US); Robert Kozlowski, Concord, MA (US)

Correspondence Address: DALY, CROWLEY & MOFFORD, LLP, SUITE 101, 275 TURNPIKE STREET, CANTON, MA, 02021-2310, US

(21) Appl. No.: 09/855,380

(22) Filed: May 15, 2001

Related U.S. Application Data
(62) Division of application No. 09/190,565, filed on Nov. 12, 1998.

(51) Int. Cl. H01J 5/02

(52) U.S. Cl. 313/495

(57) ABSTRACT

A rectangular field emission display has a front member with a glass anode support, and a first sidewall section; the display also has a cathode substrate containing an embedded cathode; the display has a rear member with a planar section and a sidewall section; and the display has an evacuated space. The front member and the rear member enclose at least a portion of the cathode substrate. The evacuated space separates the entire anode support section and the cathode substrate.

### BACKGROUND OF THE INVENTION

The invention relates to vacuum sealed substrate enclosures for displays and, in particular, to flat panel displays, such as FEDs, that are operated at high voltages to produce brighter images.

Traditional displays, such as cathode ray tubes, include a vacuum sealed casing that is typically a glass bulb. An electron emitter, or cathode, of such displays is disposed in the sealed glass bulb. The sealed glass bulb generally includes a front glass member which supports the anode.

Newer displays, such as flat panel displays, are similar in structure but do not have a curved display as found in cathode ray tubes. The newer displays include large arrays of microelectronic emitters which are supported on a glass substrate. The glass substrate is disposed between a front glass section, which includes the anode, and a rear glass section, which is known as the funnel. The space between the front and rear glass sections in which the cathode resides is evacuated to form a vacuum. The microelectronic emitters are aligned with phosphor dots on the inside surface of the anode. The emitters emit charged particles on the phosphor dots of the anode to produce an image.

Generally, a higher absolute pressure differential allows the display to operate at higher voltages and, thus, produce a brighter image. In addition, a greater absolute pressure differential allows a longer operating life for the display. However, several problems exist which limit the ability to realize a practical high vacuum display.

For example, vibrations, temperature changes, shocks, and other stresses, which are present in hostile environments such as military aircraft, can reduce the operational life of a display. Stresses further cause the space between the anode and the cathode to be non-uniform, and spacers may be required to maintain a uniform distance between the anode and the cathode. A cylindrical flat panel display distributes some stresses, such as circumferential hoop stress, through the display more efficiently than a rectangular flat panel display; however, there is a market preference for rectangular flat panel displays.

In addition, organic sealing materials may produce gas in the evacuated space that reduces the absolute pressure of the vacuum. Also, manufacturing procedures may be complex and may result in unacceptable operational lifetimes, especially for displays used in hostile environments.

### SUMMARY OF THE INVENTION

One aspect of the invention is a field emission display having a glass front member, a cathode substrate, and a rear member. The front member includes a planar, rectangular display region and a sidewall section. The sidewall section extends about the periphery of the display region, which supports an anode. The cathode substrate is a planar, glass structure that includes field emitters disposed on an inner region of the substrate.

The sidewall section of the front member is configured to maintain the anode a predetermined distance from the inner region of the cathode substrate. An anterior space extends between the anode and the inner portion of the substrate. The anode is positioned to receive electrons emitted by the field emitters and passed to the anode through the anterior space. The anterior space between the anode and the inner region of the cathode is void of support structure.

The rear member is a glass structure that includes a transverse section and a sidewall section. The sidewall section maintains the transverse section a predetermined distance from the inner region of the cathode substrate. A posterior space extends between the transverse section and the inner portion of the substrate.

Another aspect of the invention is a field emission display that includes a glass front member having a rectangular planar display region, a glass rear member, and a glass cathode substrate. The display is produced by a process that includes spacing the cathode substrate a predetermined distance from the display region. A space, which is void of structural support, extends between the display region and the cathode substrate. In addition, the display is heated and sealed, and the space is evacuated.

Each embodiment of the invention may include one or more of the following advantages. The display has an ultra high vacuum. The display has an absolute pressure differential in the range of 10⁻⁶-10⁻⁹ Torr. The display can be constructed at an elevated temperature. The display can be sealed with an inorganic sealant. The display can be operated at relatively high voltages. The potential difference between the cathode and the anode can be approximately 6-8 KV or more. The display can be operated when subject to stresses such as strong vibrations, shocks, or temperature changes. The display has a long operational life, even when subject to hostile environments or high voltages for an extended period. The display maintains acceptable spacing between the anode and the cathode without additional structural support, such as spacers, within the periphery of the anode and the cathode. The display can be rectangular.

### BRIEF DESCRIPTION OF THE DRAWINGS

FIG. 1 is a perspective view of a display according to the invention;

FIG. 2 is a cross-sectional side view of a flat panel display wherein a cathode substrate extends entirely between a front member and a rear member, and wherein the distance between the front member and the cathode substrate is supported only at the periphery of the front member and the periphery of the cathode substrate;

FIG. 3 is an exploded view of the front member, the cathode substrate and the rear member of the display of FIG. 1 wherein the display has not been completely assembled;

FIG. 4 is a perspective view of the rear member of FIG. 1 wherein the rear member includes four cathode supports;

FIG. 5 is an exploded view of another display according to the invention wherein the rear member has an alternate configuration of eight ribs which are cathode supports and heat sinks;

FIG. 6 is a graph which illustrates two possible oven heating profiles used to seal a display according to the invention;

FIG. 7 is a cross-sectional side view of an alternate embodiment of a tube to evacuate a display according to the invention and to support a cathode of the display; and

FIG. 8 is a cross-sectional side view of another display according to the invention wherein a cathode substrate and a rear member are wider than a front member.

### DESCRIPTION OF THE PREFERRED EMBODIMENTS

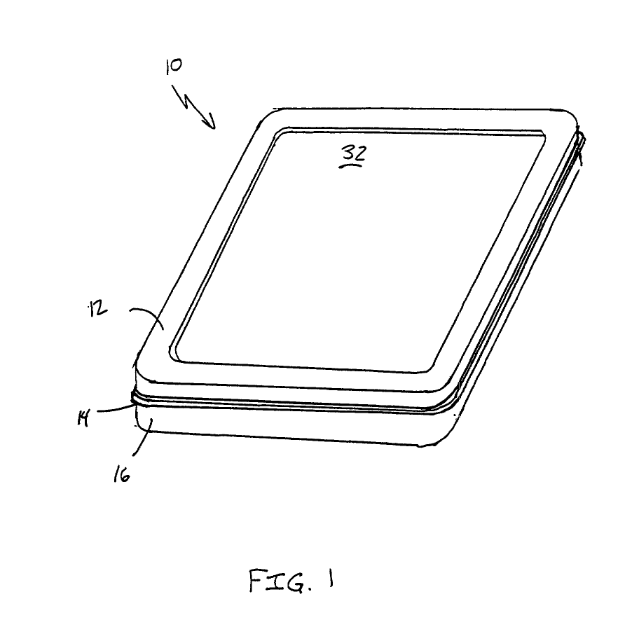

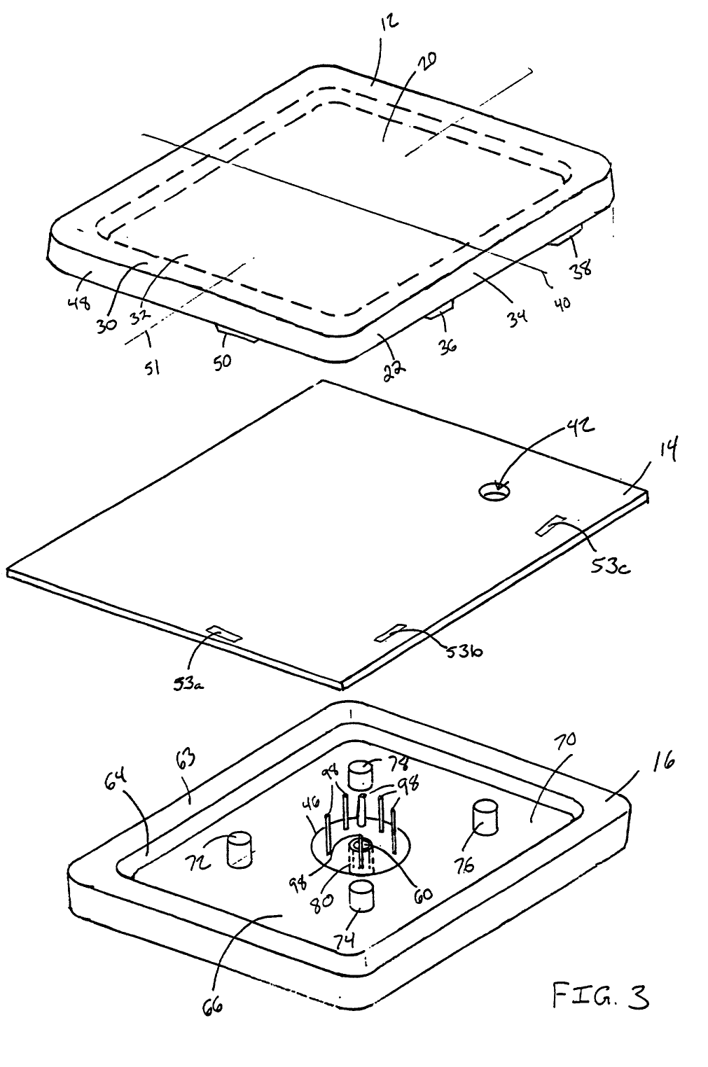

Referring to FIGS. 1-3, a display 10 is a rectangular, flat panel, field emission display (FED) that also contains characteristics, such as pressed glass, found in CRT displays. Display 10 includes a front member 12, a cathode substrate 14, and a rear member 16. When display 10 is fully assembled, cathode substrate 14 extends between front member 12 and rear member 16. Cathode substrate 14 is wider than both front and rear members 12, 16. Therefore, cathode substrate 14 abuts both front member 12 and rear member 16, and front member 12 does not abut rear member 16.

Display 10 includes a contiguous space 18 that includes both an anterior space 18a that lies between front member 12 and cathode substrate 14 and a posterior space 18b that lies between rear member 16 and cathode substrate 14. Space 18 is an evacuated space that forms a vacuum, relative to the space exterior to display 10. Electronic emissions pass through anterior space 18a when display 10 is in operation. A hole 42 in cathode substrate 14 connects anterior space 18a and posterior space 18b.

Front member 12 is translucent soda-lime glass that contains lead to reduce the brittleness of the glass. The glass and has a coefficient of thermal expansion of 87±1×10⁻⁷/° C. Front member 12 is formed from a pressed glass process that can be performed by Lancaster Glass Company of Lancaster, Ohio.

Front member 12 is a front panel that, in combination with cathode substrate 14 and rear member 16, encloses an anode 13 and a cathode 15 of display 10. Front member 12 includes a planar section 20 and a sidewall section 22. Planar section 20 and sidewall section 22 are integral sections of front member 12. Sidewall section 22 extends about the periphery of front member 12 in a direction that is generally perpendicular to planar section 20. Sidewall 22 is a peripheral support that spaces front member 12 from cathode substrate 14. The depth of sidewall section 22, i.e., the distance from an edge 24 of sidewall section 22 to an interior surface 26 of planar section 20, is dependent on the focal length of the display 10. For example, the depth of sidewall section 22 is 0.178″±0.015″, the thickness of sidewall section 22 is 0.25″, and the thickness of planar section 20 between inside surface 26 and an exterior surface 28 is 0.360″-0.400″. Edge 24 is ground flat to within a tolerance of 0.0015 and is acid fortified.

Reference notches 36, 38, 50 are used to align front member 12 and cathode substrate 14 such that a precise image is produced. One edge 34 of sidewall 22 includes two reference notches 36, 38. Reference notches 36, 38 extend 0.39″ along the length of edge 34 and each reference notch 36, 38 lies 1.995″ from bisecting axis 40. An adjacent edge 48 includes the third reference notch 50. Reference notch 50 extends 0.39″ along the length of edge 48 and lies 1.190″ from a second bisecting axis 51 that is normal to axis 40.

Planar section 20 has an area 30 that is 6.9″ square and further includes a display region 32 that is 6.3″ square. Display region 32 supports anode 13 of display 10 and is the portion of planar section 20 onto which electronic emissions that form an image are cast. Therefore, to ensure image quality, display region 32 is manufactured to higher tolerances. For example, exterior surface 28 is ground and polished such that planar section 20 contains no visible striations. The exterior surface 28 of area 30 is ground flat within a tolerance of 0.030″, and the exterior surface 28 of display region 32 is ground flat within a tolerance of 0.010″.

Sidewall section 22 spaces display region 32 from cathode substrate 14 about the periphery of display 10, and display region 32 is parallel to cathode substrate 14. No additional supports, such as spacers or other mechanisms, extend from display region 32 to cathode substrate 14. Therefore, the entire area of display region 32 is separated from cathode substrate 14 by evacuated space 18 for at least a portion of the distance between display region 32 and cathode substrate 14. Other structures, e.g., a mesh focus screen 50, lie between cathode substrate 14 and display region 32. However, no additional support structures extend the entire distance between cathode substrate 14 to display region 32.

Cathode substrate 14 is a substrate of soda-lime float glass that is commonly manufactured for use in flat panel displays. Cathode substrate 14 is 1.0 mm thick and extends slightly beyond the outer edges of front member 12 and rear member 16. The periphery of cathode substrate 14 abuts front member 12 to support cathode substrate 14 within evacuated space 18. Cathode substrate 14 and front member 12 are a uniform distance apart, e.g., 2 mm to 10 mm apart. Space 18 extends between the entire areas of cathode substrate 14 and front member 12 that lie within sidewall 22. Hole 42 extends through cathode substrate 14 within the area bounded by sidewall 22. Hole 42 equalizes the pressure on both sides of cathode substrate 14 and connects contiguous space 18 in which the vacuum is ultimately formed.

Cathode substrate 14 also includes three alignment points 53a-53c that each correspond to the positions of reference notches 36, 38, 50 of front member 12. When mated to reference notches 36, 38, 50, alignment points 53a-53c align cathode substrate 14 and front member 12. Interior surface 26 of front member 12 supports anode 13 that includes an array of photoluminescent locations. Each location is a phosphor dot that emits light when struck with an electrical charge. The float glass substrate of cathode substrate 14 contains an embedded array of microelectronic emitters that have corresponding gate electrodes. The portion of cathode substrate 14 that contains the emitters forms cathode 15 of display 10.

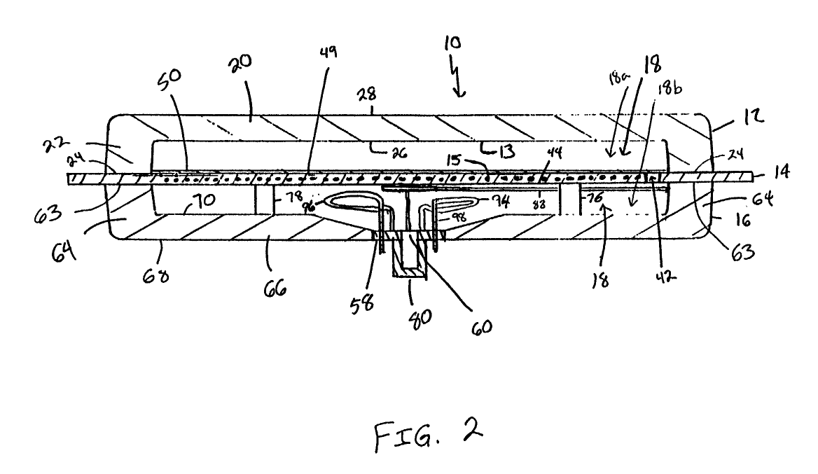

Cathode 15 occupies an inner region of cathode substrate 14 that lies within the periphery of sidewall section 22 when front member 12 abuts cathode substrate 14. In display 10, the inner region is an active region that contains the electronic emitters that form cathode 15 along a surface 49 of the cathode substrate. (However, to distinguish the structures of FIG. 2, cathode 15 is shown slightly below surface 49.) Groups of emitters correspond to the phosphor dots on the inside surface 26 of front member 12. Typically, many emitters, e.g., 100 or more, form a pixel. Each pixel is aligned with a corresponding photoluminescent location on anode 13.

Mesh focus screen 50 extends over the surface 49 of cathode substrate 14 that is oriented toward the front member 12. For example, a focus screen 50 as described in U.S. Pat. No. 5,543,691 may be used. U.S. Pat. No. 5,543,691 is incorporated herein by reference.

Rear member 16 is a rear enclosure for the cathode of display 10. Rear member 16 is translucent soda-lime glass that contains lead to decrease brittleness of the glass. The glass has a coefficient of thermal expansion of 87±1×10⁻⁷/° C. Like front member 12, rear member 16 is formed from a pressed glass process. Unlike typical CRT displays that have angled or sloped rear funnels, rear member 16 includes a transverse section 66 that is formed flat. Alternatively, transverse section 66 could be formed with a gradual curve or as a funnel.

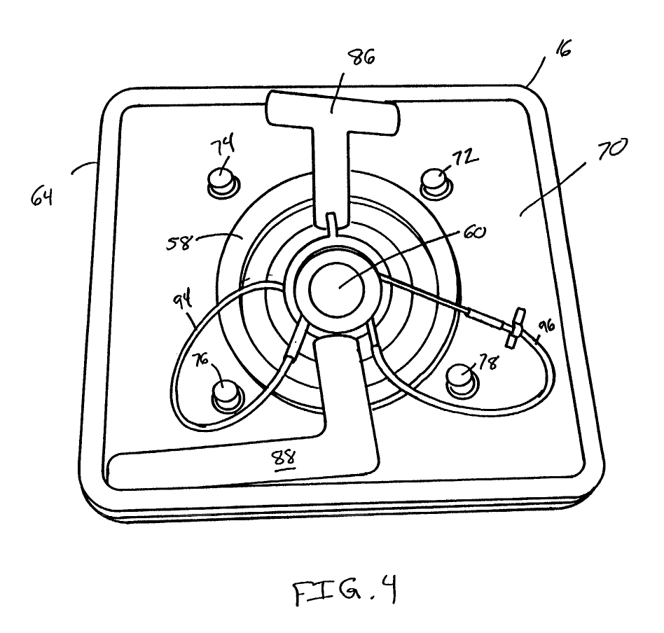

Also referring to FIG. 4, rear member 16 includes a sidewall section 64. Transverse section 66 and sidewall section 64 are integral sections of rear member 16. Sidewall section 64 extends about the periphery of rear member 16 in a direction that is generally perpendicular to transverse section 66. Transverse section 66 is 6.9″ square, and the outer periphery of sidewall section 64 is 7.4″±0.040″ square. The depth of sidewall section 64, i.e., the distance from an edge 63 of sidewall section 68 to the inside surface 70 is 0.120″-0.160″. The thickness of sidewall section 64 is 0.250″, and the thickness of transverse section 66 between inside surface 70 and outside surface 68 is 0.350″-0.390″. Edge 63 is ground flat to within a tolerance of 0.0015″ and is acid fortified.

Rear member 16 includes four substrate supports 72, 74, 76, 78 and a stem 58. Stem 58 further includes an evacuation tube 80 and six electrical connections 98 arranged in a generally circular pattern. Stem 58 is a standard structure found on CRT displays that provides an electrical connection to the cathode substrate 14. A hole 46 is bored into center 60 of rear member 16. Stem 58 is a circular glass disk that resides within hole 46 and is secured by a flame sealed seam that melts glass around stem 58.

Tube 80 extends from the center of stem 58. Before evacuation of space 18, tube 80 is approximately 5″ long and open at both ends. After evacuation, tube 80 is melted and cut off near the outside surface 68 of rear member 16 leaving a short stump of approximately 0.25″. Thus, tube 80 is closed to permanently seal evacuated space 18. Tube 80 can be cut and sealed such that tube 80 is nearly flush with the surface of rear member 16. Tube 80 can be completely flush with the surface of rear member 16, but, when tube 80 is cut flush with the surface of rear member 16, the associated additional stresses may weaken the seal on the display and cause failure at lower pressures.

Substrate supports 72, 74, 76, 78 are posts that extend from inside surface 70 of rear member 16 to a backside surface 44 of cathode substrate 14. Substrate supports 72, 74, 76, 78 dampen and absorb vibration loads and other shocks. In addition, substrate supports 72, 74, 76, 78 act as heat sinks by absorbing heat and forming a thermally conductive path from cathode substrate 14 to rear member 16. Substrate supports 72, 74, 76, 78 help maintain the cathode 15 within an operating temperature range of 32° C. to 40° C.

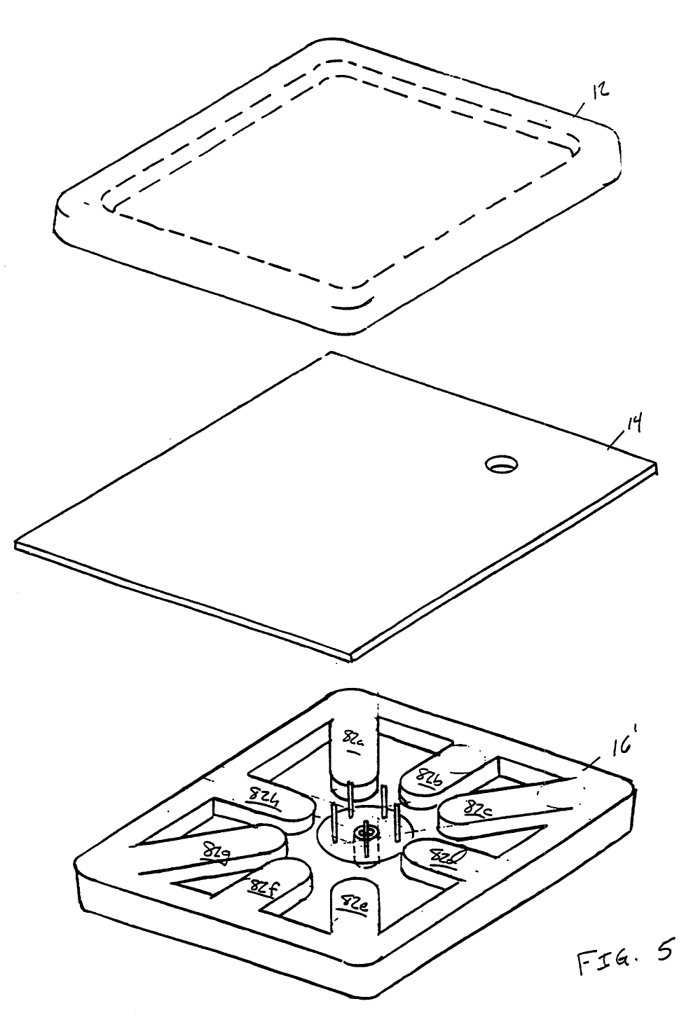

Substrate supports 72, 74, 76, 78 are made of soda-lime glass and are attached to the rear member 16 by devitrifying frit. Substrate supports 72, 74, 76, 78 are approximately 0.25″ in diameter. Substrate supports 72, 74, 76, 78 allow the thickness of the rear member 16 to be relatively smaller because the composite action of cathode supports 72, 74, 76, 78 reduces the structural requirements of rear member 16. Alternatively, substrate supports 82a-82h of a rear member 16′, which form eight radially arranged ribs, as shown in FIG. 5, can be used to increase the effectiveness of the thermally conductive path and provide additional structural support for cathode substrate 14.

Rear member 16 includes several additional features such as an anode connection 86, a focus connection 88, and getter material, e.g., barium, that is contained in corresponding channels of two metallic wires 94, 96 arranged in loops and spaced away from surfaces 44 and 70. Anode connection 86 and focus connection 88 each attach to a corresponding one of the electrical connections 98. Wires 94, 96 each attach to two corresponding electrical connections 98 at respective ends of wires 94, 96. After display 10 is sealed, wires 94, 96 are heated such that the getter material is expelled from the corresponding channels in wires 94, 96. The getter material forms a metal film upon the surfaces within space 18. The film absorbs substances that are out-gassed within space 18 and that would otherwise be in a gaseous state within space 18.

During the glass manufacturing process, soda-ash regulates the coefficient of thermal expansion of members 12, 16. In display 10, the mechanical properties of the float glass of cathode substrate 14 dictate the mechanical properties of the pressed glass of front member 12 and rear member 16, because cathode substrate 14 is commonly manufactured and available from existing vendors while members 12, 16 are custom manufactured. Therefore, the coefficients of thermal expansion of the soda-lead glass of front member 12 and rear member 16 are tuned to closely match the coefficient of thermal expansion of the pre-existing soda-lime glass of cathode substrate 14. The coefficient of thermal expansion of the pressed glass of front and rear members 12, 16 is within ±2.0×10⁻⁷/° C. of the coefficient of thermal expansion for the float glass of cathode substrate 14. After the sections 12, 14, 16 are sealed, the matched coefficients of thermal expansion for each section 12, 14, and 16 are verified with a polariscope that is used to estimate post anneal stress and by CTE measurements.

Lead oxide is used in the manufacturing process to maximize toughness of the pressed glass. Toughness is the measure of energy required to extend a crack through the glass. The toughened glass improves yield during the coring of rear member 16 and further ruggedizes display 10.

The assembly process for display 10 includes three separate oven heating phases. Front member 12 and rear member 16 are sealed to cathode substrate 14 with a devitrifying frit, e.g., CV-455 manufactured by Owens Illinois. The frit has a coefficient of thermal expansion of approximately 86.0×10⁻⁷/° C. The modulus of elasticity of the frit can be up to 30% lower than the modulus of elasticity for soda-lime glass, which has a modulus of elasticity of approximately 10.0 e⁶ lbs/in². The relative softness of the frit seal joint contributes to the strength of the display 10.

Before the first oven cycle, the devitrifying frit is applied to the sidewalls of the front member 12 and the rear member 16. In the first heating phase, organic components are baked out of the frit. Subsequently, the three sections 12, 14, and 16 are placed in an alignment assembly that aligns the assembled sections 12, 14, and 16. The emitters of cathode substrate 14 are aligned with phosphor dots of front member 12. However, some misalignment typically occurs.

Several factors contribute to the total misalignment between front member 12 and cathode substrate 14 including, first, a mismatch in the coefficients of thermal expansion of front member 12, cathode substrate 14, and rear member 16 and, second, oven temperature. Misalignment can be reduced when the coefficients of thermal expansion are closely matched. For example, when the coefficients of thermal expansion of the pressed glass sections 12, 16 are 2.0×10⁻⁷/° C. greater than the coefficients of thermal expansion of the float glass cathode substrate 14, misalignment has been measured at 10.6 microns in both the lateral and longitudinal directions. A reduction of the maximum heating temperature, as discussed below, can also reduce misalignment.

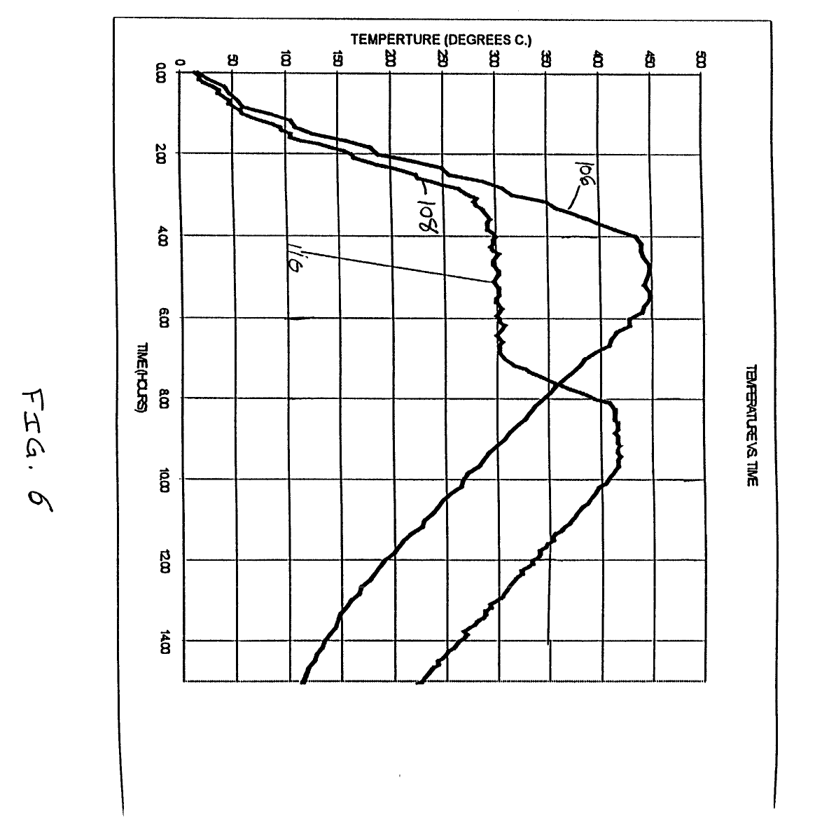

During the second heating phase, the alignment assembly secures sections 12, 14, and 16 at an angle to horizontal within the vacuum furnace, e.g., planar section 20 is at a 22° angle to horizontal. Referring to FIG. 6, the temperature within the vacuum furnace is varied over time to minimize thermal gradients within the assembled sections 12, 14, and 16 and maximize frit strength. The heating process minimizes thermal gradients by providing an unimpeded path from the heat source to planar surface 28 of front member 12. Thus, front member 12 absorbs heat evenly across planar surface 28, which also reduces the thermal gradients from front member 12 through rear member 16. The temperature difference between front member 12 and funnel section 14 has been measured at approximately 4° C.

FIG. 6 illustrates two heating curves 106, 108 that may be used to produce a display according to the invention. Curve 108 contains an additional hold period 110 of approximately 2.5 hours at 300° C. that allows the maximum temperature of curve 108 to be reduced to approximately 430° C. as opposed to the maximum temperature of 450° C. in curve 106.

Generally, a high vacuum display should be sealed at the minimum temperature available that results in an acceptable seal. An elevated temperature is required when a display contains an inorganic frit (as opposed to an organic sealant), but an inorganic frit is preferable to an organic sealant for several reasons. For example, organic sealants generally fail at lower absolute pressures and, additionally, require structures to counter the higher rate of out-gassing. In display 10, the getter material that is expelled by wires 94, 96, extending within space 18 between cathode substrate 14 and rear member 16, is sufficient to absorb any gasses produced within space 18 by the out-gassing of residual components from the inorganic frit and other components. The out-gassing is minimal when the inorganic frit is thoroughly baked and fully crystallized.

The amount of out-gassing depends on the materials and their stability, especially in response to temperature and pressure. Organic frits, inorganic frits and other materials will out-gas and the rate depends on the porosity of the material, the chemical characteristics of the material, and the types of gasses to which the material has been exposed. (For example, members exposed to argon have out-gassed argon during processing.) The members 12, 16 and cathode substrate 14 will out-gas. However, an extended temperature cycle during sealing reduces the rate of out-gassing in the sealed display 10. The getter material also removes some of the gases and maintains or improves the vacuum in the display.

Both curves 106, 108 have a maximum temperature below the strain point of the float glass of cathode substrate 14, which is approximately 500° C. The lower temperature of curve 108 minimizes stress in the pressed glass and reduces misalignment of the emitters embedded in cathode substrate 14 and the phosphor dots contained on inside surface 26 of front member 12. Sealing the display above the strain point of the glass results in reduced viscosity of the glass that produces variations in the mechanical properties of the glass. The variations can not be effectively measured with a dilatometer at a temperature above the strain point of the glass. Also, at a temperature above the strain point of the glass, the glass experiences a non-linear increase in the volume of the glass that results in a non-linear increase in the coefficient of thermal expansion of the glass at that temperature.

The strain point of the pressed glass is approximately 410° C., but, the CV-455 frit may not adequately seal sections 12, 14, 16 when processed significantly below the manufacturer's recommended maximum temperature of, e.g., 440° C.-450° C. for the Owens Illinois frit. On the other hand, however, assembling display 10 at temperatures near 450° for 1.5 hours as in curve 106 may cause partial annealing of the pressed glass. Partial annealing can increase stresses in the glass. Thus, an acceptable time and temperature profile for the assembly process should balance a reduction of the stresses in the float glass and pressed glass while producing an acceptable seal.

For example, a slow ramp rate of 1.4° C./minute to the maximum temperature of 430° C. results in devitrification in approximately 70 minutes while reducing the stresses produced in the float glass and the pressed glass. Additionally, a heating profile that devitrifies the frit and produces an acceptable seal at a temperature less than or equal to 410° C. would further reduce stresses on display 10. Examination of CV-455 frit samples indicate that a maximum temperature below 430° C. is possible. For example, CV-455 frit samples heated to maximum temperatures below 430° C. exhibited a dull finish indicating complete crystallization when examined with the naked eye and, when examined with an electron microscope, exhibited similar grain size and growth patterns to samples heated to 450° C.

In the final heating phase, the sealed display 10 is heated and evacuated through evacuation tube 80 and permanently sealed. Alternatively, display 10 could be evacuated and sealed in the vacuum furnace, which would eliminate the need for the final step. The design and assembly process of display 10 reduces stresses that may be caused by mismatched coefficients of thermal expansion and thermal gradients in display 10 when the frit crystallizes.

Other embodiments are within the scope of the invention.

The dimensions in the detailed description of display 10 correspond to one embodiment of a rectangular flat panel display. Displays larger than display 10 will typically have larger dimensions, e.g., spacing between the cathode and the anode, than the dimensions of display 10. Displays smaller than display 10 will typically have smaller dimensions than the dimensions of display 10. However, displays which have many other combinations of dimensions and which provide many different values for parameters, such as different operating voltage levels and different absolute vacuum levels, are within the scope of the claims.

For example, a 4″×4″ display having a 0.2″ thick sidewall section, a 0.35″ thick planar section, and four substrate supports has been pressure tested to as much as 75 psi absolute. A 6″×6″ display having a 0.3″ thick sidewall section and a 0.55″ thick planar section has been tested at 35 psi absolute. Other configurations and dimensions will result in embodiments of the invention which allow vacuums through a broad range of absolute pressure differentials.

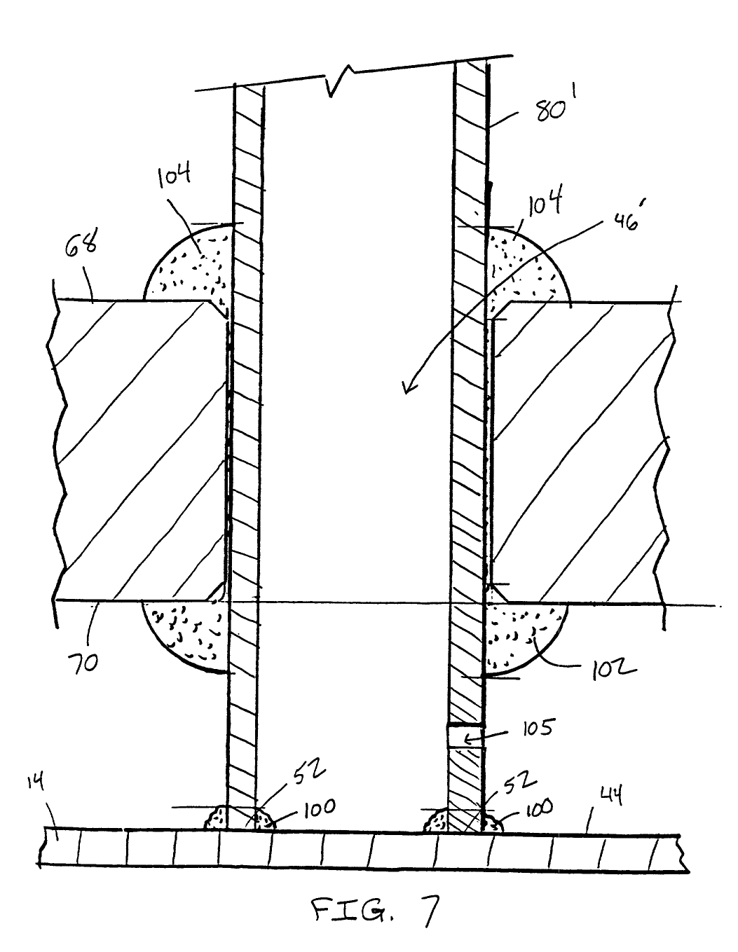

Also, as shown in FIG. 7, an alternate structure can be used to evacuate space 18. Tube 80′ is extended through hole 46′ that is bored into the center 60 of rear member 16. Hole 46′ has a diameter from 0.245″ minimum to 0.255″ maximum. Tube 80′ is a hollow cylinder that has a 0.035″ wall thickness and an outer diameter from 0.233″ minimum to 0.235″ maximum. Tube 80′ extends through hole 46′, and an inner end 52 of tube 80′ contacts the back surface 44 of cathode substrate 14. Tube 80′ contains a second hole 105 through which space 18 is evacuated. A bead of devitrifying frit 100 secures tube 80 to cathode substrate 14. The electrical connections, which are provided through stem 58 in display 10, are provided elsewhere and no stem is present in the present embodiment. Hole 46′ is further sealed with a continuous bead of frit 102 placed about hole 46′ along an inside surface 70 of rear member 16. Three additional non-continuous dots of frit 104 are placed about hole 46′ along an outside surface 68 of rear member 16.

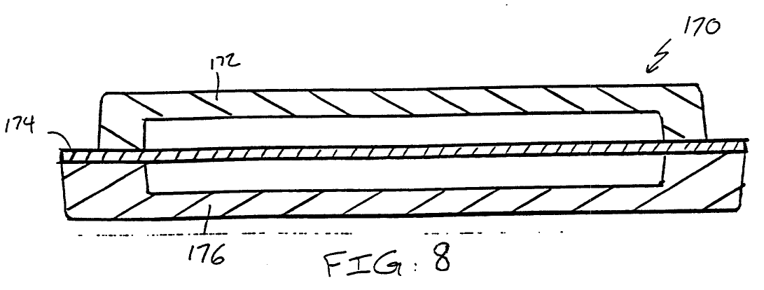

Referring to FIG. 8, alternate structures can be used to create an effective vacuum seal. For example, display 170 includes an front member 172, a cathode section 174, and a funnel section 176. Front member 172 is narrower than both cathode section 174 and funnel section 176, which have equal widths.

Additionally, the sidewalls of the front members and funnel sections for all displays can be tapered to maximize strength and minimize weight. The tapered sections can be thickened locally in areas of high stress.

One skilled in the art will appreciate that the embodiments of the claimed invention disclosed herein represent tradeoffs between many factors and that many alterations and additions may be made to the disclosed embodiments without departing from the scope of the claimed invention. Information, such as structural dimensions, heating curves, and test results, is provided to exemplify the specific embodiments within the scope of the claims and is not intended to limit the scope of the claims.

What is claimed is:

1. A field emission display, comprising:
a glass front member having a planar, rectangular display region and a sidewall section, the sidewall section extending about the periphery of the display region, the display region supporting an anode;
a planar, glass cathode substrate having field emitters disposed on an inner region of the substrate;
wherein the sidewall section of the front member is configured to maintain the anode a predetermined distance from the inner region of the cathode substrate to provide an anterior space between the anode and the inner portion of the substrate, the anode being positioned to receive electrons emitted by the field emitters and passed to the anode through the anterior space; and
wherein the anterior space between the anode and the inner region of the cathode is void of support structure to maintain the predetermined distance between the inner region of the substrate and the display region.

2. The display of claim 1 further comprising a glass rear member having a transverse section and a sidewall section; and
wherein the sidewall section of the rear member maintains the transverse section a predetermined distance from the inner region of the substrate to provide a posterior space between the transverse section and the inner portion of the substrate.

3. The display of claim 2 wherein the transverse section is rectangular and planar.

4. The display of claim 2 further comprising a substrate support extending between the cathode substrate and the rear member.

5. The display of claim 4 wherein the substrate support extends between the inner region of the cathode substrate and the transverse section of the rear member.

6. The display of claim 4 wherein the substrate support provides a thermally conductive path extending from the cathode to the rear member.

7. The display of claim 4 wherein the substrate support further comprises a single post located at a center of the rear member.

8. The display of claim 4 wherein the substrate support further comprises a plurality of posts.

9. The display of claim 4 wherein the substrate support further comprises a plurality of ribs.

10. The display of claim 1 wherein the coefficient of thermal expansion of the front member is within ±2.0×10⁻⁷/° C. inclusive of the coefficient of thermal expansion of the cathode.

11. The display of claim 1 wherein the front member further comprises a first type of glass and the cathode substrate further comprises a second type of glass.

12. The display of claim 11 wherein the first type of glass comprises pressed glass.

13. The display of claim 11 wherein the second type of glass comprises float glass.

14. The display of claim 11 wherein the rear member comprises the first type of glass.

15. The display of claim 2 wherein the anterior space and the posterior space are contiguous spaces.

16. The display of claim 1 wherein the anterior space has an absolute pressure less than 10⁻⁶ Torr.

17. The display of claim 1 wherein the anterior space has an absolute pressure in the range of 10⁻⁶ to 10⁻⁹ Torr.

18. The display of claim 2 further comprising an inorganic sealant adapted to seal the display and isolate the anterior space from space exterior to the display.

19. The display of claim 18 wherein the inorganic sealant is disposed along a surface of the sidewall section of the front member.

20. The display of claim 18 wherein the inorganic sealant is disposed along a surface of the sidewall section of the rear member.

21. The display of claim 18 wherein the inorganic sealant is disposed about an evacuation tube of the display.

22. The display of claim 18 wherein the inorganic sealant is disposed about an electrical connection of the display.

23. The display of claim 1 wherein the anode and the emitters are adapted to withstand at least 6,000 volts.

24. The display of claim 1 wherein the anode and the emitters are adapted to withstand at least 8,000 volts.

25. The display of claim 1 wherein the rear member is wider than the front member.

26. The display of claim 1 wherein the cathode substrate is narrower than the front member.

27. The display of claim 1 wherein the display region and the cathode substrate are parallel.

28. The display of claim 27 wherein a distance between the display region and the cathode substrate is less than or equal to 0.193 inches.

29. The display of claim 3 wherein the transverse section of the rear member further comprises a substantially planar interior surface, a distance between the cathode substrate and the interior surface being less than or equal to 0.160 inches.

30. A field emission display, comprising:
a glass front member having a planar, rectangular display region and a sidewall section, the sidewall section extending about the periphery of the display region, the display region supporting an anode;
a planar, glass cathode substrate having field emitters disposed on an inner region of the substrate;
wherein the sidewall section of the front member is configured to maintain the display region a predetermined distance from the inner region of the cathode substrate to provide an anterior space between the anode and the inner portion of the substrate, the anode being positioned to receive electrons emitted by the field emitters and passed to the anode through the anterior space; and
wherein the anterior space further comprises an evacuated space extending between the inner region of the cathode substrate and an entire portion of the display region.

31. A field emission display having a glass front member having a rectangular planar display region, a glass rear member, and a glass cathode substrate, the display being produced by a process comprising the steps of:
(a) spacing the cathode substrate a predetermined distance from the display region such that a space extending between the display region and the cathode substrate is void of structural support;
(b) heating the display;
(c) sealing the display;
(d) evacuating the space.

32. The display of claim 31 further comprising the step of providing structural support between the cathode substrate and the rear member.

33. The display of claim 31 wherein the process further comprises the step of providing a thermally conductive path to transfer heat from the cathode substrate to an exterior of the display.

34. The display of claim 31 wherein the step of sealing the enclosure further comprises sealing the enclosure with an inorganic sealant.

35. The display of claim 31 wherein the step of heating the display further comprises heating the display to a maximum temperature below the strain point of the cathode substrate.

36. The display of claim 31 wherein the step of heating the display further comprises heating the display to a maximum temperature below the annealing temperature of the cathode substrate.

37. The display of claim 31 wherein the step of heating the display further comprises heating the display to a maximum temperature below the strain point of the front glass member.

38. The display of claim 31 wherein the step of heating the display further comprises heating the display to a maximum temperature below the annealing temperature of the front glass member.

39. The display of claim 31 further comprising the step of sealing an evacuation port of the display.

40. The display of claim 39 wherein the evacuation port further comprises a glass evacuation tube and the step of sealing an evacuation port further comprises melting a portion of the glass evacuation tube such that the tube is sealed at a point flush with a surrounding surface of the display.
